(19) United States
(12) Patent Application Publication
(10) Pub. No.: US 2007/0000113 A1
(43) Pub. Date: Jan. 4, 2007

(54) FUEL INJECTOR PULLING TOOL

(76) Inventor: Richard Desilets, Bellingham, MA (US)

Correspondence Address: MOORE & VAN ALLEN PLLC, P.O. BOX 13706, Research Triangle Park, NC, 27709, US

(21) Appl. No.: 11/428,144

(22) Filed: Jun. 30, 2006

Related U.S. Application Data
(60) Provisional application No. 60/696,348, filed on Jun. 30, 2005.

(51) Int. Cl. B23P 19/04

(52) U.S. Cl. 29/256

(57) ABSTRACT

A tool is provided for removing a fuel injector from a cylinder head. The tool comprises a pair of threaded bolts and an engaging member. The engaging member has a pair of threaded openings for threadably receiving each of the bolts. The engaging member is positioned adjacent the fuel injector such that when the bolts are threaded into the engaging member, the distal end of the bolts will engage the cylinder head moving the engaging member in a direction toward the proximal end of the bolt. The engaging member engages and drives the fuel injector axially outward relative to the cylinder head for extracting the fuel injector from the head.

### CROSS-REFERENCES TO RELATED APPLICATIONS

This application is related to U.S. provisional application No. 60/696,348, filed Jun. 30, 2005, entitled “Tool System”, naming Richard D. Desilets as the inventor. The contents of the provisional application are incorporated here by reference in their entirety, and the benefit of the filing date of the provisional application is hereby claimed for all purposes that are legally served by such claim for the benefit of the filing date.

### BACKGROUND

This invention relates generally to a hand tool for pulling a part outwardly from a seated location, and more particularly to a hand tool for pulling a fuel injector outwardly from a seated location in an engine.

Fuel injectors must be removed from an internal combustion engine for cleaning, repair, or replacement. The fuel injectors of many engines, including many large diesel engines, slide into and out of their operating position and are held in their operative position by bolts that act upon flanges on the injector and threadably engage mounting holes in the head of the engine. Removal of fuel injectors is often very difficult because the area around the fuel injectors is constricted and little space exists for positioning a tool relative to the cylinder head in which the injectors are located. This is especially true of diesel engines wherein the injectors feed fuel directly into the combustion chamber. Further, the same difficulties present themselves when installing fuel injectors.

For the foregoing reasons, there is a need for a tool which can be inserted into the head/block of an engine fro removing a fuel injector from its bore. Ideally, the tool should also be useful for installing fuel injectors.

### SUMMARY

According to the present invention, a tool is provided for removing a fuel injector from a cylinder head of an engine having at least one mounting hole for the fuel injector. The tool comprises a pair of threaded bolts having a proximal end and a distal end. An engaging member is provided for engaging the fuel injector. The engaging member has a pair of threaded openings for threadably receiving each of the bolts. The engaging member is positioned adjacent the fuel injector such that when the bolts are threaded into the engaging member, the distal end of the bolts will engage the cylinder head moving the engaging member in a direction toward the proximal end of the bolt. The engaging member engages and drives the fuel injector axially outward relative to the cylinder head for extracting the fuel injector from the head.

### BRIEF DESCRIPTION OF THE DRAWINGS

For a more complete understanding of the present invention, reference should now be had to the embodiments shown in the accompanying drawings and described below. In the drawings:

FIG. 1 is an exploded perspective view of a conventional fuel injector and a cylinder head of an engine.

FIG. 2 is an elevation view of the fuel injector shown in FIG. 1 installed in the cylinder head which is shown in partial cross-section.

FIG. 3 is an exploded perspective view of an embodiment of a tool for removing and installing a fuel injector according to the present invention.

FIG. 4 is an elevation view of the fuel injector and cylinder head shown in FIG. 2 with the tool shown in FIG. 3 in partial cross-section and in place for removing the fuel injector.

FIG. 5 is an elevation view as shown in FIG. 4 with the tool engaging a flange on the fuel injector.

FIGS. 6 and 7 are elevation views from opposite sides showing the tool installed on the fuel injector.

FIG. 8 is a perspective view of another conventional fuel injector and a cylinder head of an engine.

FIG. 9 is an elevation view of the fuel injector and cylinder head shown in FIG. 8 with the tool shown in FIG. 3 in place for removing the fuel injector.

FIG. 10 is an elevation view as shown in FIG. 9 with the tool engaging a flange on the fuel injector.

FIGS. 11 and 12 are elevation views from opposite sides showing the tool installed on the fuel injector.

### DESCRIPTION

Certain terminology is used herein for convenience only and is not to be taken as a limitation on the invention. For example, words such as “upper,” “lower,” “left,” “right,” “horizontal,” “vertical,” “upward,” and “downward” merely describe the configuration shown in the FIGS. Indeed, the components may be oriented in any direction and the terminology, therefore, should be understood as encompassing such variations unless specified otherwise.

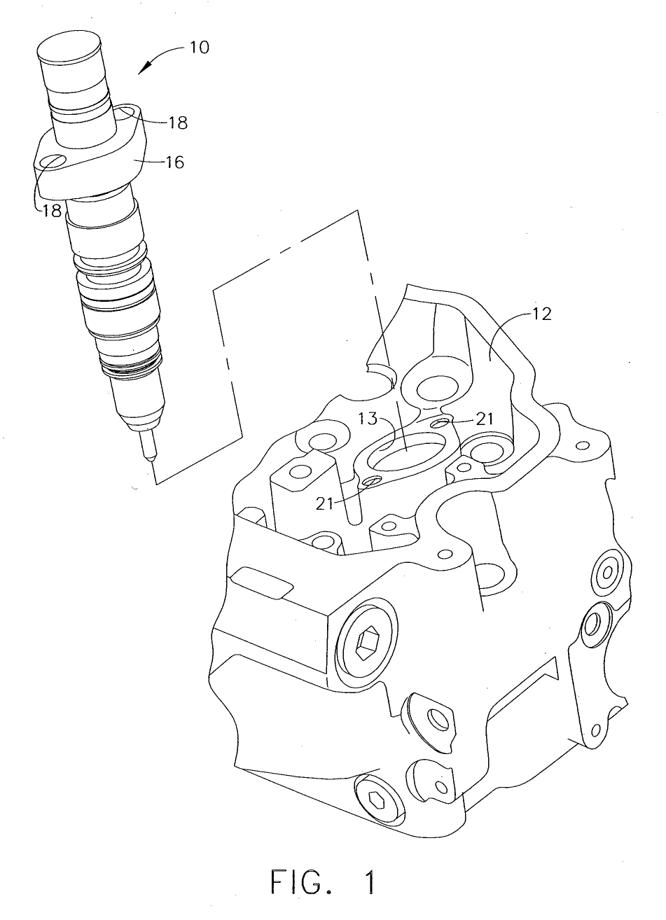

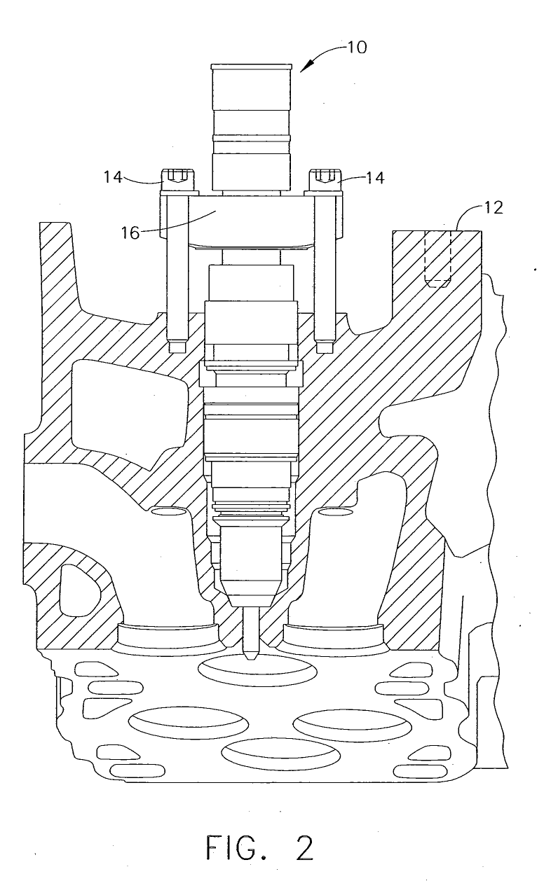

Referring now to the drawings, wherein like reference numerals designate corresponding or similar elements throughout the several views, FIG. 1 is an exploded perspective view of a conventional fuel injector 10 and a cylinder head 12 of an engine. The cylinder head 12 defines a bore 13 for receiving the fuel injector 10. The fuel injector 10 includes a lip, or flange 16, having a pair of opposed bolt holes 18. Referring to FIG. 2, mounting bolts 14 are provided for seating the fuel injector 10 to the cylinder head 12. The mounting bolts 14 pass through the bolt holes 18 in the flange 16 and are received in threaded mounting holes 20 in the cylinder head 12.

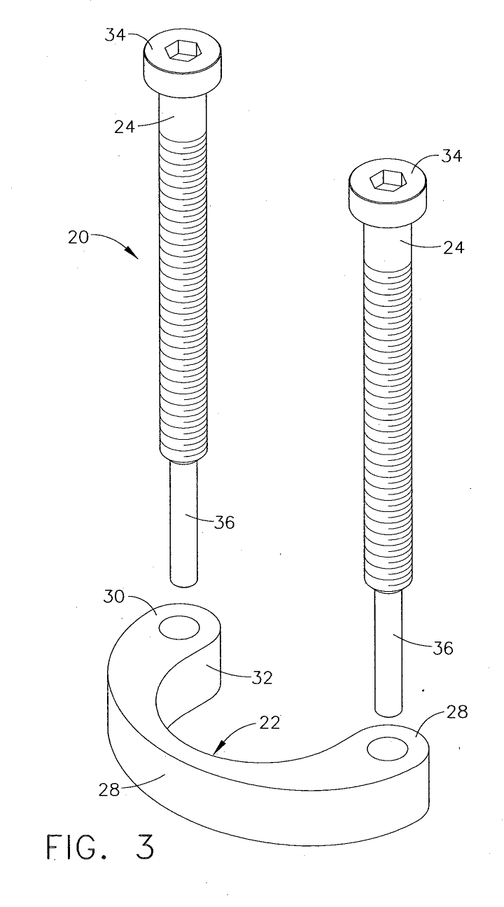

An embodiment of a hand tool according to the present invention for removing a fuel injector 10 from a cylinder head 12 of an engine is shown in FIG. 3, and generally designated at 20. The tool 20 includes a fuel injector engaging member 22 and a pair of bolts 24. The fuel injector engaging member 22 comprises a generally flat plate, including a central portion 26 and a first leg 28 and a second leg 30 extending from the central portion 26 for defining a C-shaped recess 32. The distance between the legs 28, 30 is at least slightly larger than the width of the body of the fuel injector 10 such that the legs 28, 30 are adapted to partially surround opposing sides of the fuel injector 10 being removed, as will be described below. The fuel injector engaging member 22 may be formed from flat bar stock approximately one-half inch thick.

The bolts 24 have a proximal end 34 and a distal end 36. The proximal end 34 of each bolt 24 comprises a hexagonal head for rotating the bolt 24 using a conventional wrench (not shown). Preferably, the head 34 of each bolt 24 is sized to require the same size hexagonal tool as the mounting bolts 14 for the fuel injector 10. The bolts 24 are threaded along their length, except for a reduced diameter portion of the bolt 24 adjacent the distal end 36 of the bolt 24. The fuel injector engaging member 22 has a pair of oppositely positioned threaded holes 38 in the legs 28, 30 for threadably receiving the bolts 24.

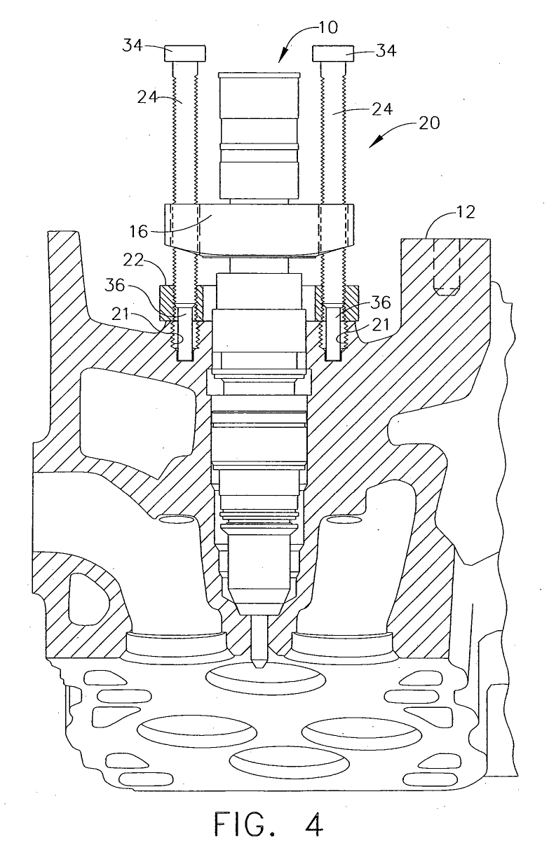

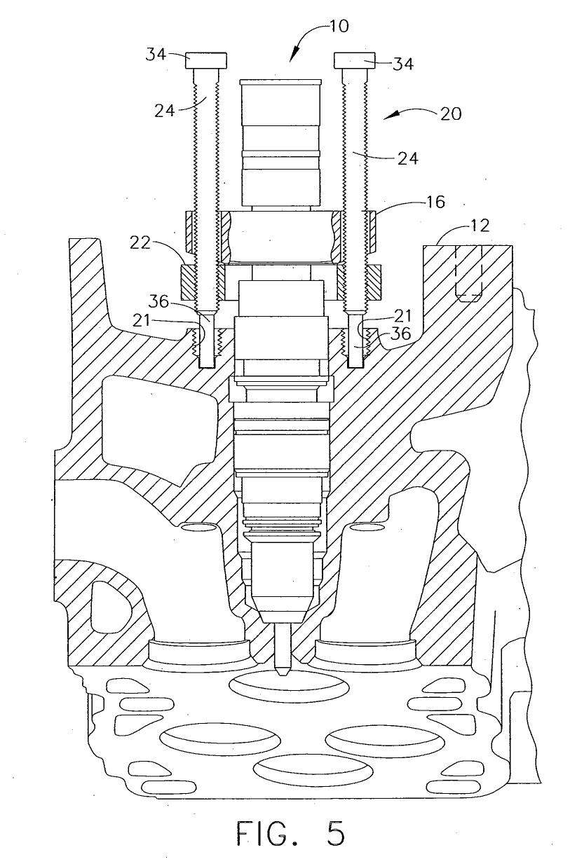

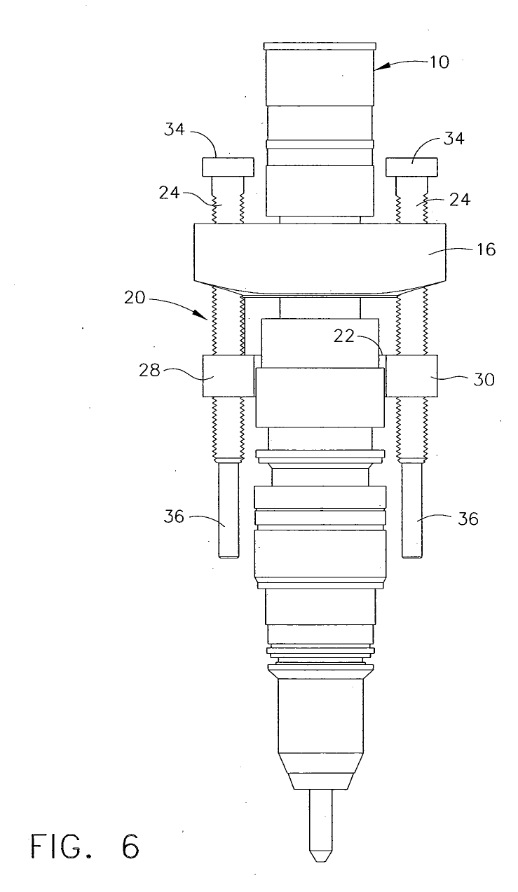

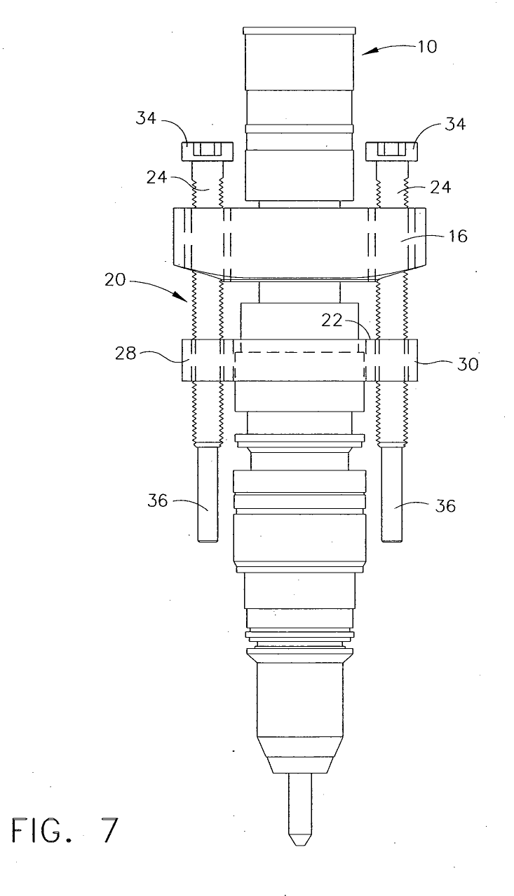

For removing a fuel injector 10 using the tool and method according to the present invention, the mounting bolts 14 holding the fuel injector 10 in the cylinder head 12 are removed from the threaded mounting holes 20. Referring to FIG. 4, the fuel injector engaging member 22 is disposed adjacent the body of the fuel injector 10 between the flange 16 on the fuel injector 10 and the cylinder head 12. The fuel injector engaging member 22 is positioned such that the holes 38 in the legs 28, 30 are aligned with the holes 18 in the flange 16 of the fuel injector 10 and the mounting holes 20 in the cylinder head 12. In this position, the fuel injector engaging member 22 partially surrounds the body of the fuel injector 10. Each of the bolts 24 is inserted through the holes 18 in the flange 16 and threaded into the holes 38 in the fuel injector engaging member 22. The bolts 24 are progressively advanced into the mounting holes 20 in the cylinder head 12 until the distal ends 36 of the bolts 24 reach the bottom of the mounting holes 20. The bolts 24 are then threadably advanced evenly, which moves the fuel injector engaging member 22 in a direction toward the proximal end of the bolts 24 until the fuel injector engaging member 22 contacts the bottom surface of the flange 16 of the fuel injector 10, as shown in FIG. 5. Continued threading advancement of the bolts 24 causes relative movement of the fuel injector 10 axially outwardly of the cylinder head 12 until the fuel injector 10 is removed. FIGS. 6 and 7 show the tool 20 installed on the fuel injector 10 from opposite sides following removal of the fuel injector 10.

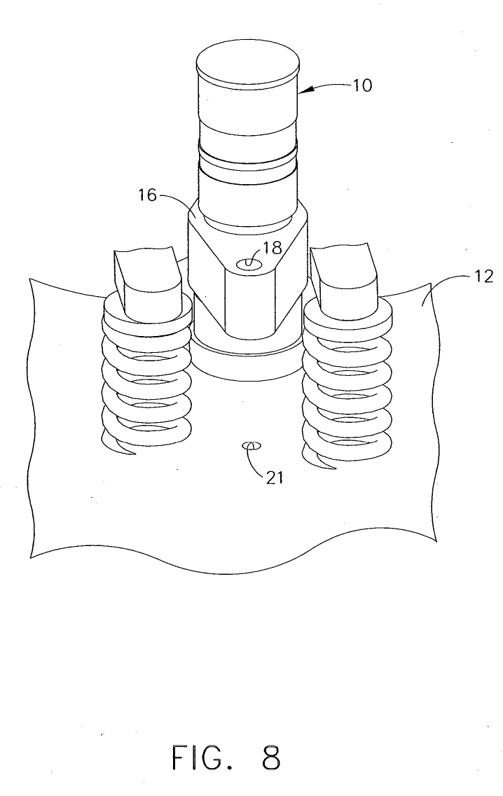

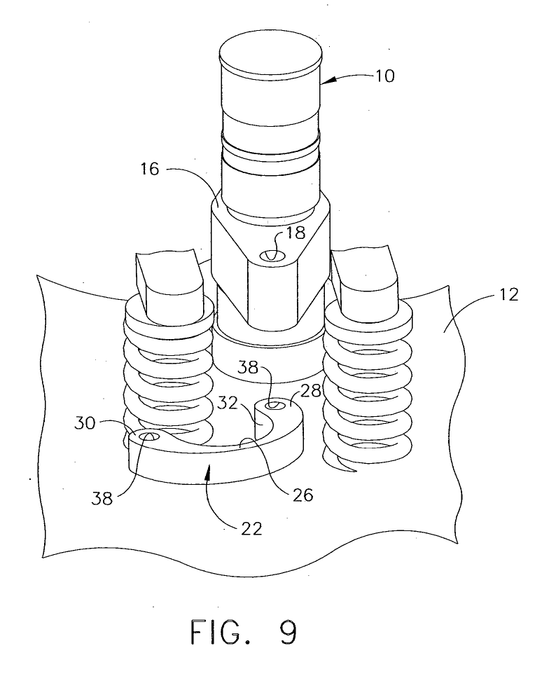

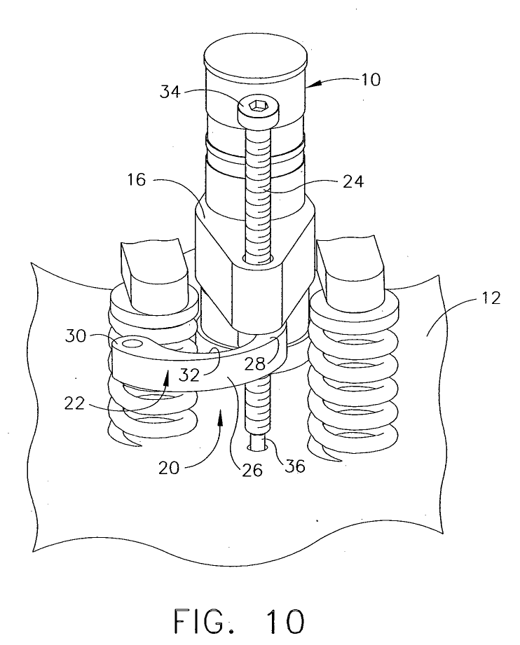

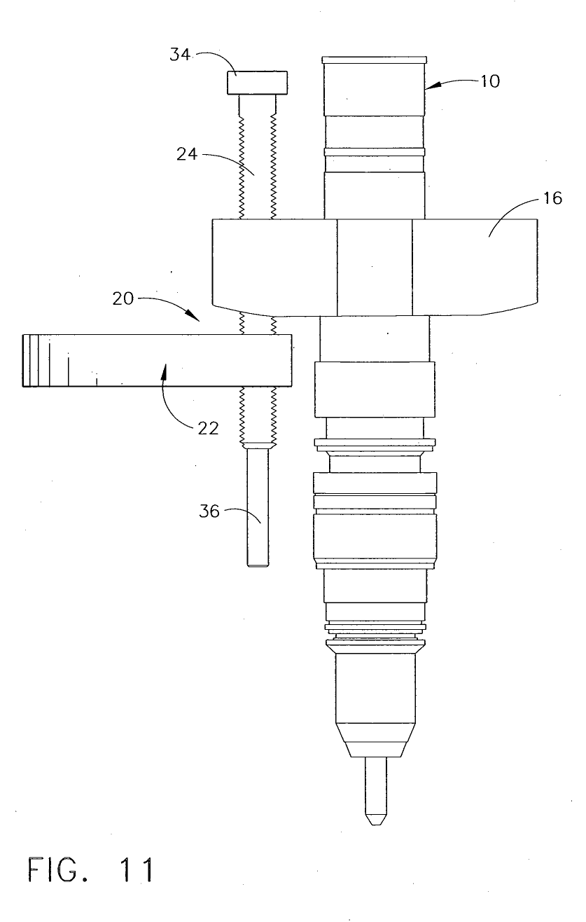

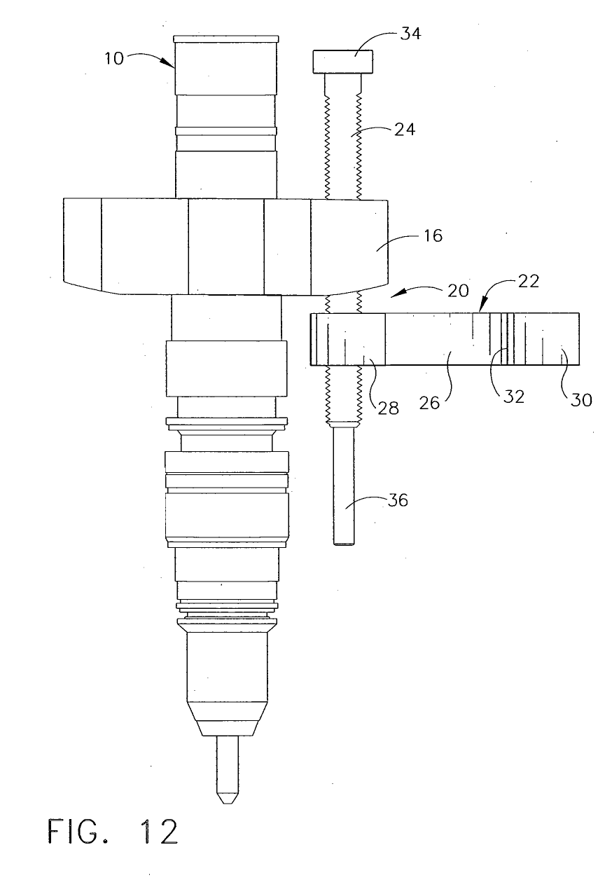

FIG. 8 shows a fuel injector 10 that is accessible to the tool 20 from only one side due to the position of the valves relative to the fuel injector 10. The fuel injector 10 may be removed using the tool and method according to a second embodiment of the present invention. Referring to FIG. 9, one leg 28 of the fuel injector engaging member 22 is disposed adjacent the body of the fuel injector 10 between the flange 16 on the fuel injector 10 and the cylinder head 12. The fuel injector engaging member 22 is positioned such that the hole 38 in the leg 28 is aligned with the hole 18 in the flange 16 of the fuel injector 10 and the mounting hole 20 in the cylinder head 12. In this position, the other leg 30 of the fuel injector engaging member 22 engages the valve spring. As shown in FIG. 10, a bolt 24 is inserted through the hole 18 in the flange 16 and threaded into the hole 38 in the fuel injector engaging member 22. The bolt 24 is progressively advanced into the mounting hole 20 in the cylinder head 12 until the distal end 36 of the bolt 24 reaches the bottom of the mounting hole 20. The bolt 24 is then threadably advanced, which moves the fuel injector engaging member 22 in a direction toward the proximal end of the bolt 24 until the fuel injector engaging member 22 contacts the bottom surface of the flange 16 of the fuel injector 10. Continued threading advancement of the bolt 24 causes relative movement of the fuel injector 10 axially outwardly of the cylinder head 12 until the fuel injector 10 is removed. FIGS. 11 and 12 show the tool 20 installed on the fuel injector 10 from opposite sides following removal of the fuel injector 10. It is understood that a second tool may be used on the other side of the fuel injector assuming there is sufficient space.

For installing a fuel injector 10, the tool 20 is disposed against the upper surface of the flange 16 of the fuel injector 10 such that the holes 38 in the legs 28, 30 of the fuel injector engaging member 22 are aligned with the holes 18 in the flange 16 and the mounting holes 20 in the cylinder head 12. The bolts 24 are threaded into the holes 38 in the fuel injector engaging member 22 such that a length of the bolts 24 extends through the flange 16. Pressure is applied on the top of the bolts 24 for forcing the fuel injector 10 down into the injector bore 13 to a position where the mounting bolts 14 will threadably engage the mounting holes 20 for drawing the fuel injector 10 into place where the fuel injector 10 seats against the cylinder head 12.

Although the present invention has been shown and described in considerable detail with respect to only a few exemplary embodiments thereof, it should be understood by those skilled in the art that I do not intend to limit the invention to the embodiments since various modifications, omissions and additions may be made to the disclosed embodiments without materially departing from the novel teachings and advantages of the invention, particularly in light of the foregoing teachings. For example it would be possible to connect multiple tools together with a hinge pin to increase the versatility of the tool. Any configuration where the tool has an engaging point of contact to stop it from turning in any shape could be expanded on. Accordingly, I intend to cover all such modifications, omission, additions and equivalents as may be included within the spirit and scope of the invention as defined by the following claims. In the claims, means-plus-function clauses are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

I claim:

1. A tool for removing a fuel injector from a cylinder head of an engine having at least one mounting hole for the fuel injector, the tool comprising:
a pair of threaded bolts having a proximal end and a distal end; and
an engaging member for engaging the fuel injector, the engaging member having a pair of threaded openings for threadably receiving each of the bolts,
wherein the engaging member is positioned adjacent the fuel injector such that when the bolts are threaded into the engaging member, the distal end of the bolts will engage the cylinder head moving the engaging member in a direction toward the proximal end of the bolt for engaging and driving the fuel injector axially outward relative to the cylinder head for extracting the fuel injector from the head.

2. A tool as recited in claim 1, wherein the proximal end of the bolt is hexagonal.

3. A tool as recited in claim 1, wherein the distal end of each bolt has an unthreaded length and a diameter such that the end of the bolt slidably fits into the mounting hole

4. A tool as recited in claim 1, wherein the threaded openings are oppositely disposed.

5. A tool as recited in claim 1, wherein the engaging member is flat.

6. A tool as recited in claim 1, wherein the engaging member defines a recess for receiving at least a portion of the injector.

7. A tool as recited in claim 1, wherein the recess is semi-circular and defined by oppositely disposed first and second legs extending from a central portion.
